(19) United States
(12) Patent Application Publication
(10) Pub. No.: US 2023/0241957 A1
(43) Pub. Date: Aug. 3, 2023

(54) KINETIC ENERGY TRANSFERENCE DEVICE METHOD AND DEVICES

(71) Applicants: Karin M Somoza, Los Angeles, CA (US); Eleanor Somoza, Los Angeles, CA (US)

(72) Inventors: Karin M Somoza, Los Angeles, CA (US); Eleanor Somoza, Los Angeles, CA (US)

(21) Appl. No.: 18/132,957

(22) Filed: Apr. 10, 2023

Related U.S. Application Data
(63) Continuation-in-part of application No. 17/829,210, filed on May 31, 2022, now Pat. No. 11,623,507.
Application No. 17/829,210 is a continuation of application No. 17/488,020, filed on Sep. 28, 2021, now Pat. No. 11,345,226.

(51) Int. Cl. B60K 6/10; B60K 6/30; B60K 25/02; B60K 6/365; B60K 6/543

(52) U.S. Cl. CPC B60K 6/105; B60K 6/30; B60K 6/365; B60K 6/543; B60K 25/02

(57) ABSTRACT

A continuously variable transmission system for a vehicle comprising a continuously variable transmission with plural sensors configured to collect vehicle data and quantities of regenerated energy recovered, an energy control module coupled to the plural sensors and configured to analyze the vehicle data to determine a net amount of energy used less an energy regenerated amount, a preferred travel route and an estimated cost for the vehicle to travel on the preferred travel route, a navigation controller coupled to the energy control module and configured to navigate the vehicle along the preferred travel route, a display device coupled to the navigation controller and configured to display the estimated cost and the preferred travel route in real-time on an interactive map and a mobile device configured to display on the mobile device in real time the estimated cost and the preferred travel route and to alter the preferred travel route.

### CROSS-REFERENCED TO RELATED APPLICATIONS

This application is a continuation-in-part of prior U.S. application Ser. No. 17/829,210, filed May 31, 2022, which is a continuation of prior U.S. application Ser. No. 17/488,020, filed Sep. 28, 2021, and now issued as U.S. Pat. No. 11,345,226, filed by Karin M. Somoza, the U.S. Patent Applications being incorporated herein by reference.

### BACKGROUND

Flywheel technology has been around for a long time and has many benefits over other energy storage systems. The one major drawback is the energy loss to add and draw energy out of the flywheels. An electric motor/generator loses energy through heat/friction during both the input and output phases. Chemical batteries used to store energy experience excess heat from massive power inputs or outputs causing loss of energy.

### BRIEF DESCRIPTION OF THE DRAWINGS

FIG. 1 shows for illustrative purposes only an example of a kinetic energy transference device of one embodiment.

FIG. 2 shows for illustrative purposes only an example of a planetary gear system of one embodiment.

FIG. 3A shows for illustrative purposes only an example of a flywheel storage system of one embodiment.

FIG. 3B shows for illustrative purposes only an example of a vacuum-sealed flywheel storage system of one embodiment.

FIG. 4 shows a block diagram of an overview of a speed and force control module of one embodiment.

FIG. 5 shows a block diagram of an overview of a gate or speed governor of one embodiment.

FIG. 6A shows for illustrative purposes only an example of a lobed disc of one embodiment.

FIG. 6B shows for illustrative purposes only an example of a lobed disc coupled to a planetary gear system from the gear set perspective of one embodiment.

FIG. 6C shows for illustrative purposes only an example of a lobed disc coupled to a planetary gear system from the lobed disc perspective of one embodiment.

FIG. 7 shows for illustrative purposes only an example of a planetary gear system movement of one embodiment.

FIG. 8 shows a block diagram of an overview of primary kinetic source combustion engines on automobiles of one embodiment.

FIG. 9 shows a block diagram of an overview of the primary kinetic source electric motor/generator of one embodiment.

FIG. 10 shows a block diagram of an overview of primary kinetic source devices with large starting energy demands of one embodiment.

FIG. 11 shows for illustrative purposes only an example of a primary kinetic source of one embodiment.

FIG. 12 shows for illustrative purposes only an example of a transfer gears of one embodiment.

FIG. 13 shows for illustrative purposes only an example of a hydraulic actuator coupled to a lobed disc of one embodiment.

FIG. 14A shows for illustrative purposes only an example of a hybrid automobile regenerative brakes of one embodiment.

FIG. 14B shows for illustrative purposes only an example of acceleration and braking for hybrid automobile regenerative brakes of one embodiment.

FIG. 15A shows for illustrative purposes only an example of the acceleration kinetic energy flow of one embodiment.

FIG. 15B shows for illustrative purposes only an example of the braking kinetic energy flow of one embodiment.

FIG. 16 shows a block diagram of an overview of additional applications and features of one embodiment.

FIG. 17 shows a block diagram of an overview of a multiple-axis mechanism of one embodiment.

FIG. 18 shows a block diagram of an overview of the KETD features of one embodiment.

FIG. 19 shows a block diagram of an overview of a computer application of one embodiment.

FIG. 20 shows a block diagram of an overview of an energy control module of one embodiment.

### DETAILED DESCRIPTION OF THE INVENTION

In a following description, reference is made to the accompanying drawings, which form a part hereof, and in which are shown by way of illustration a specific example in which the invention may be practiced. It is to be understood that other embodiments may be utilized, and structural changes may be made without departing from the scope of the present invention.

### General Overview

It should be noted that the descriptions that follow, for example, in terms of a kinetic energy transference device method and devices are described for illustrative purposes and the underlying system can apply to any number and multiple types of use applications. In one embodiment of the present invention, the kinetic energy transference device method and devices can be configured using a multiple-axis mechanism. The kinetic energy transference device method and devices can be configured to include a gate or speed governor and can be configured to include a computer-controlled module using the present invention.

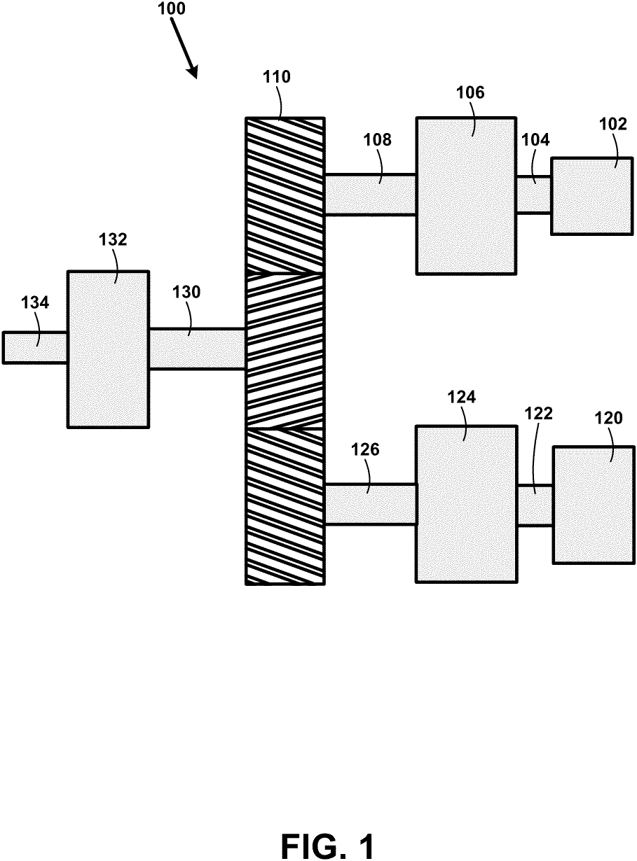

FIG. 1 shows for illustrative purposes only an example of a kinetic energy transference device of one embodiment. FIG. 1 shows a kinetic energy transference device 100 with a primary kinetic source, for example, a gas engine 102 transferring force through the primary kinetic source axle 104 of FIG. 1 to CVT planetary gear system and gate #1 106. The transferred force is input #1 108 which is transferred to a planetary gear set 110. The transferred force is stored in the flywheel storage system 120 through the CVT planetary gear system secondary kinetic axle 122 and gate #2 124 in one instance. In another instance, force is transferred from the flywheel storage system 120 through the CVT planetary gear system and gate #2 124 to INPUT #2 axle 126 to the planetary gear set 110.

In one embodiment from the planetary gear set 110 force (kinetic energy) is transferred to an automobile wheel 134 through an output automobile wheel 130 axle through a CVT planetary gear system and gate #3 132. In another embodiment force (kinetic energy) is transferred from the automobile wheel 134 through the CVT planetary gear system and gate #3 132 and output automobile wheel 130 axle to the planetary gear set 110. This force is stored in the flywheel storage system 120 in one embodiment.

The kinetic energy transference device (KETD) 100 is integrated into a continually variable transmission (CVT) planetary gear system 110. A primary kinetic source is coupled to the primary kinetic source axle 104. The primary kinetic source axle 104 is coupled to the primary kinetic source transfer gear. A first-speed governed kinetic energy transfer gear coupled to the first-speed governor transfers the measured amount of kinetic energy needed to provide the most efficient use of the energy for a first operation through the first-speed governed kinetic energy axle.

The excess speed is always transferred into the moving gate. This moving gate flows at the speed that is subtracted from the input speed to provide the desired output speed. No excess speed leaves the CVT planetary gear system. The speed is divided into two paths, with one being the speed of the gate and the other being to flow out to the desired load. The first computer-controlled module analyses the kinetic energy imparted from the primary kinetic source and the kinetic energy needed to provide the most efficient use of the energy for a first operation to determine the measured amount of kinetic energy to transfer through the first-speed governor. The measured amount of kinetic energy determined is transmitted to the first-speed governor. The first-speed governor adjusts the kinetic energy control devices to impart the measured amount of kinetic energy to the first speed-governed kinetic energy axle.

Data received from the second operating system is processed in the second computer-controlled module and analyzed to determine the current kinetic energy needed for the second operation. The second speed governor makes adjustments in the kinetic energy control devices to transfer additional kinetic energy to the second operating system. The additional kinetic energy from the stored kinetic energy is transferred from the KETD flywheel surplus kinetic energy transfer gear to a second speed-governed kinetic energy transfer gear coupled to a second speed-governed energy axle.

The KETD flywheel surplus kinetic energy transfer gear is coupled to the third computer-controlled module that is coupled to the KETD flywheel surplus kinetic energy axle. The third computer-controlled module receives data from the first computer-controlled module and the second computer-controlled module. The data received from the two modules are analyzed by the third computer-controlled module to determine how much surplus kinetic energy to transfer to one of the operations of one embodiment.

### Detailed Description

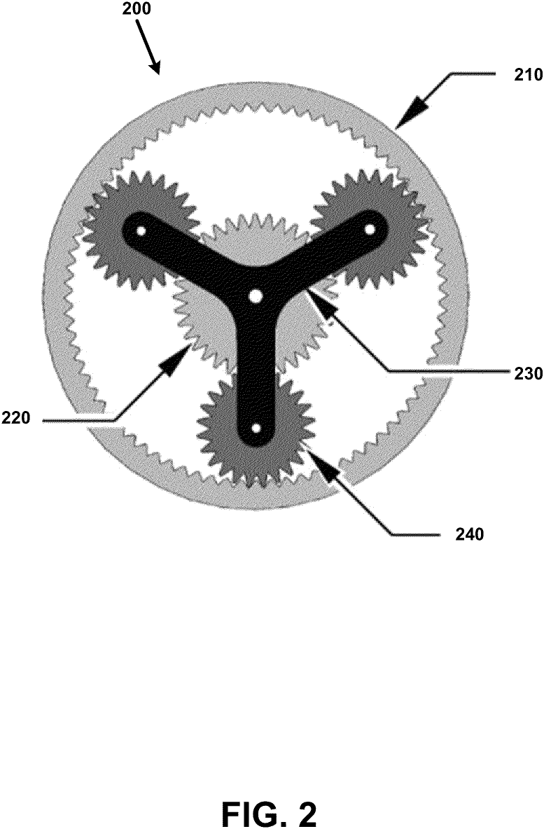

FIG. 2 shows for illustrative purposes only an example of a planetary gear system of one embodiment. FIG. 2 shows a planetary gear system 200 forming a kinetic energy transfer gear set connected to the CVT planetary gear system 110 of FIG. 1. A sun gear 220 is connected to the input side of the CVT planetary gear system 110 of FIG. 1 and each planet gear 240. A planetary carrier 230 is connected to the output side of the CVT planetary gear system 110 of FIG. 1 and each planet gear 240. A ring gear 210 is connected to the Speed Governor. The speed of the sun gear 220 (input) minus the speed of the ring gear also referred to as a speed governor equals the speed of the carrier gear 240 (Output). This calculation assumes the gears are equal in size. A change in the proportion of the gears will change the ratio but the overall effect is the same.

### Flywheel Storage System

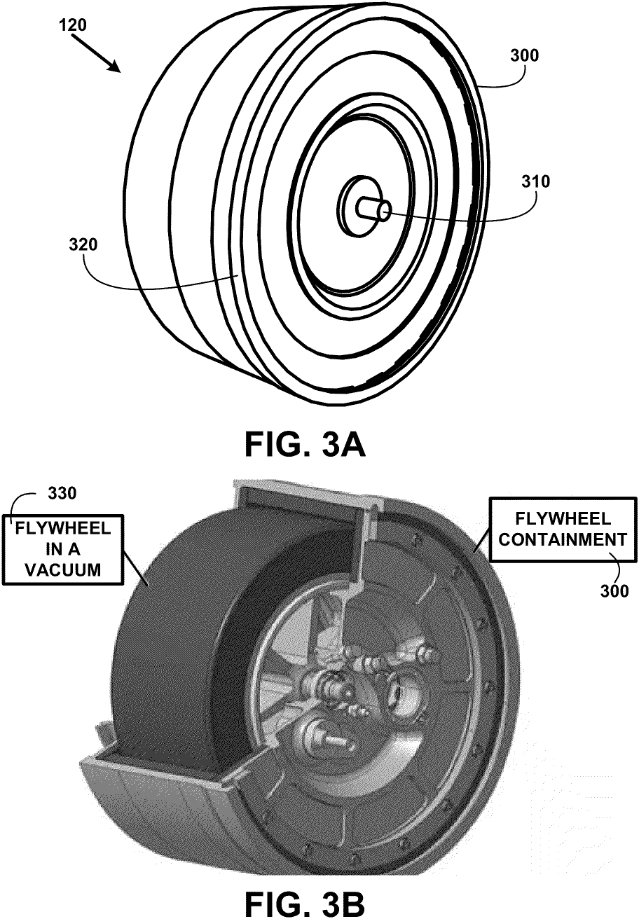

FIG. 3A shows for illustrative purposes only an example of a flywheel storage system of one embodiment. FIG. 3A shows a flywheel storage system 120 in a flywheel containment 300 housing. The flywheel containment 300 housing includes an airtight case 320 allowing a vacuum to be created inside flywheel containment housing 300. A flywheel axle 310 is rotated with a speed and force delivered through a coupled planetary gear system 200 of FIG. 2 kinetic energy transfer drive train of one embodiment.

The primary kinetic energy source of the flywheel storage system 120. The flywheel storage system 120 is coupled to the continually variable transmission (CVT) planetary gear system 110. The CVT planetary gear system 110 is integrated with a multiple-axis mechanism kinetic energy transference device. The multiple-axis mechanism kinetic energy transference devices include multiple gates or speed governors, wherein each is configured to include a computer-controlled module. The computer-controlled modules process operational data to determine the most efficient use of the kinetic energy for each operation.

The measured most efficient use amount of the kinetic energy for each operation is transmitted to the multiple gates or speed governors. The multiple gates or speed governors make adjustments in speed many times a second. The adjusted speeds transfer of the measured amount of kinetic energy for each operation is made through multiple gears and output shafts/drive shafts to serve each operation. Surplus kinetic energy not needed for operations is stored in the flywheel storage system of one embodiment.

### Flywheel in a Vacuum

FIG. 3B shows for illustrative purposes only an example of a vacuum-sealed flywheel storage system of one embodiment. FIG. 3B shows a cut-away of the flywheel containment 300 housing. The cut-away of the flywheel containment 300 housing reveals a flywheel in a vacuum 330. The creation of the vacuum surrounding the flywheel reduces drag that would be caused by air within the airtight case 320 of FIG. 3A increasing the efficiency of the flywheel of one embodiment.

### Speed and Force Control Module

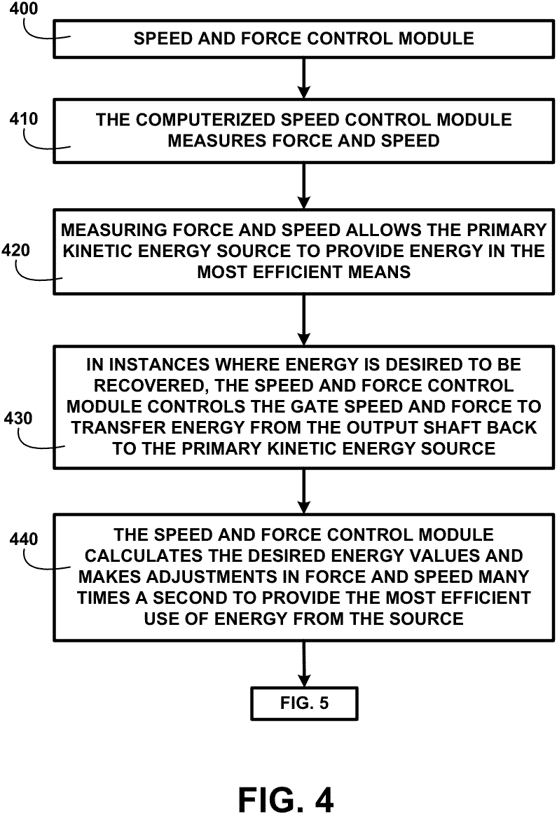

FIG. 4 shows a block diagram of an overview of a speed and force control module of one embodiment. FIG. 4 shows a speed and force control module 400. The computerized speed control module measures force and speed 410. Measuring force and speed allows the primary kinetic energy source to provide energy in the most efficient means 420. In instances where energy is desired to be recovered, the speed and force control module controls the gate speed and force to transfer energy from the output shaft back to the primary kinetic energy source 430. The speed and force control module calculates the desired energy values, makes adjustments in force, and speed many times a second to provide the most efficient use of energy from the source 440 of one embodiment.

In a system that only has an engine (power source) and an output (Automobile wheel), only one CVT planetary gear system is required since there is only one path energy can travel between the power source and automobile wheel. Regardless of which direction the energy is flowing, it can only flow through one path.

In a system where a third input/output is added, two more CVT planetary gear systems are required to cover the 2 additional paths to function with the one added force source. For example, in a system with an engine (Gas), a Flywheel storage system 120 of FIG. 1, and an automobile wheel, three CVT planetary gear systems are needed for the three different paths energy can flow. Path 1: Energy can run from the Engine to the Automobile wheel and back if needed. Path 2: Energy can run from the Engine to the Flywheel and back if needed. Path 3: Energy can run from the Flywheel to the Automobile wheel and back if needed.

There is a need for each source to have a CVT planetary gear system 120 of FIG. 1 because, in order to force energy into the desired location, the gate on the side that is not accepting or delivering the energy needs to be resisting and at a higher level than the receiving side. If you are directing energy being recovered from the Automobile wheel into the Flywheel, the Gate on the Engine side must be resisting at a higher level than the flywheel in order to force that energy into the flywheel.

When working with two or more CVT planetary gear systems with their corresponding Gate control module, a Master Control Module must be in place to correspond with the different gate controls. Continuous monitoring of the energy demands, and availability is needed to properly set the correct gate speed and force of the different CVT planetary gear system 120 of FIG. 1 gates in order to properly direct the transference of energy to and from its desired locations. Each CVT planetary gear system 120 of FIG. 1 is controlled by its own force control module. Each force control module is controlled by a Master Control Module. The master control module sets the speed and/or pressure of the CVT planetary gear system speed governors/gates to direct the energy in the direction desired. Other embodiments include an electric motor/generator in place of the gas engine with batteries to store and deliver energy.

A first speed governed kinetic energy transfer gear coupled to the first-speed governor 842 transfers the measured amount of kinetic energy needed to provide the most efficient use of the energy for a first operation through the first speed governed kinetic energy axle 844. The excess speed not needed for the first operation is transferred out a separate path to a KETD flywheel surplus kinetic energy transfer gear. The first computer-controlled module 840 includes a first digital processor and a first transceiver.

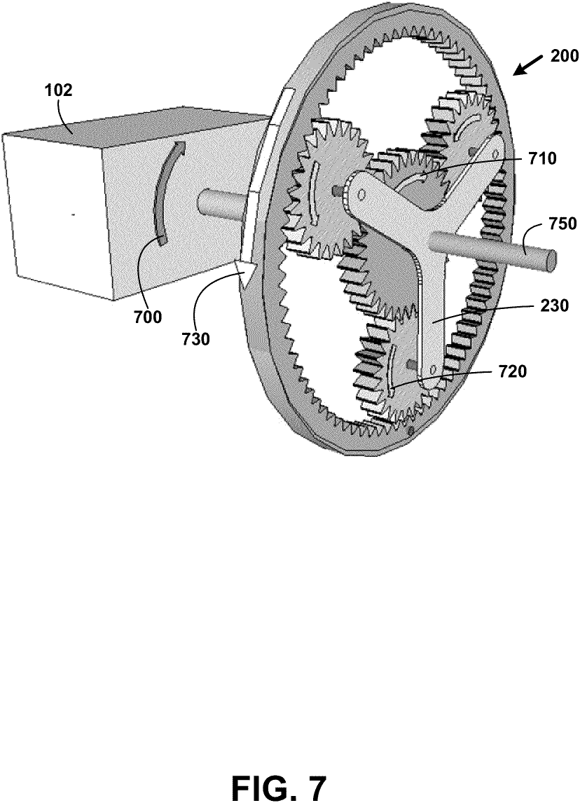

The first computer-controlled module 840 using the first digital processor analyses the kinetic energy imparted from the primary kinetic source 700 of FIG. 7 and the kinetic energy needed to provide the most efficient use of the energy for a first operation to determine the measured amount of kinetic energy to transfer through the first-speed governor 842. The measured amount of kinetic energy determined is transmitted using wirelessly bidirectional signals from the first transceiver to the first-speed governor 842. The first-speed governor 842 adjusts the kinetic energy control devices to impart the measured amount of kinetic energy to the first-speed governed kinetic energy axle 844.

Data is received through a second transceiver from the second operating system. The data provided is processed in the second computer-controlled module 850 where a second digital processor analyses the current kinetic energy needed for the second operation and existing kinetic energy being received to determine if additional kinetic energy is needed or whether the existing kinetic energy being received is more than the current kinetic energy needed creating a surplus of kinetic energy.

The determination of a shortfall or surplus is transmitted in this instance over hard-wired cabling instead of using the second-speed governor 852 installed transceiver. The second-speed governor 852 makes adjustments in the kinetic energy control devices to in one embodiment transfer additional kinetic energy to the second operating system, for example, a braking system through the second-speed governed kinetic energy axle 854.

In another embodiment, a transfer of the surplus kinetic energy from the second operating system to the second speed-governed kinetic energy transfer gear is made through the second speed-governed kinetic energy axle 854. In the latter instance, any surplus kinetic energy obtained from the second operation is transferred from the second speed-governed kinetic energy transfer gear to the KETD flywheel surplus kinetic energy transfer gear.

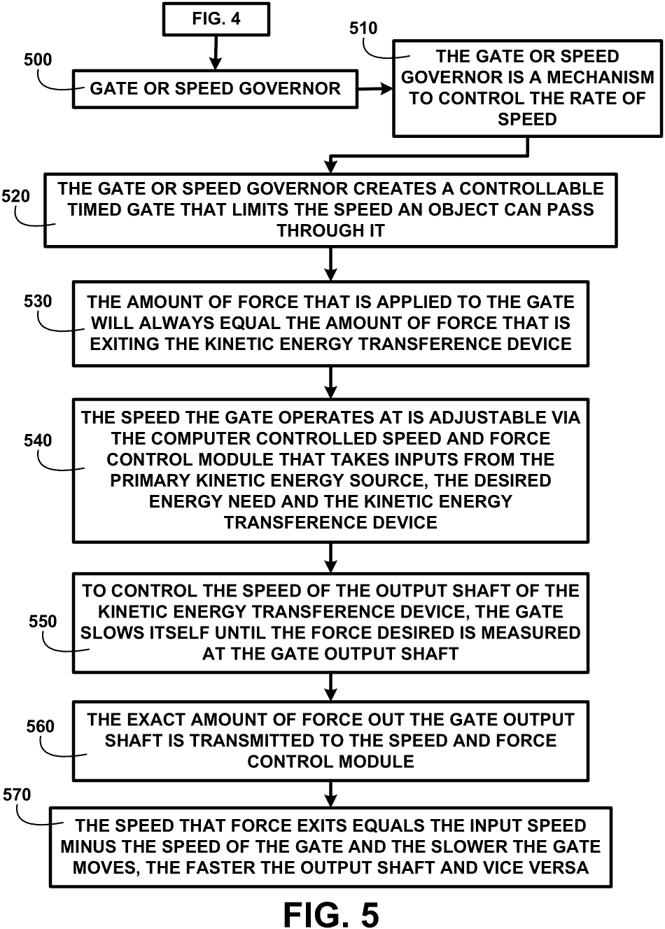

The KETD flywheel surplus kinetic energy transfer gear is coupled to the third computer-controlled module that is coupled to the KETD flywheel surplus kinetic energy axle. The third computer-controlled module includes a third digital processor and a third transceiver. The third transceiver receives data from the first computer-controlled module 840 and the second computer-controlled module 850. The data received from the two modules are analyzed by the third digital processor to determine where and how much kinetic energy to transfer surplus kinetic energy and how much surplus kinetic energy is coming from the two sources if applicable of one embodiment. The description continues in FIG. 5.

### Gate or Speed Governor

FIG. 5 shows a block diagram of an overview of a gate or speed governor of one embodiment. FIG. 5 shows a continuation from FIG. 4 showing a gate or speed governor 500. The gate or speed governor is a mechanism to control the rate of speed 510. The gate or speed governor creates a controllable timed gate that limits the speed an object can pass through it 520. The amount of force that is applied to the gate will always equal the amount of force that is exiting the kinetic energy transference device 530. The speed at the gate operates is adjustable via the computer-controlled speed and force control module that takes inputs from the primary kinetic energy source, the desired energy needed, and the kinetic energy transference device 540.

To control the speed of the output shaft of the kinetic energy transference device, the gate slows itself until the force desired is measured at the gate output shaft 550. The exact amount of force out the gate output shaft is transmitted to the speed and force control module 560. The speed that forces exit equals the input speed minus the speed of the gate and the slower the gate moves, the faster the output shaft and vice versa 570 of one embodiment.

### A Lobed Disc

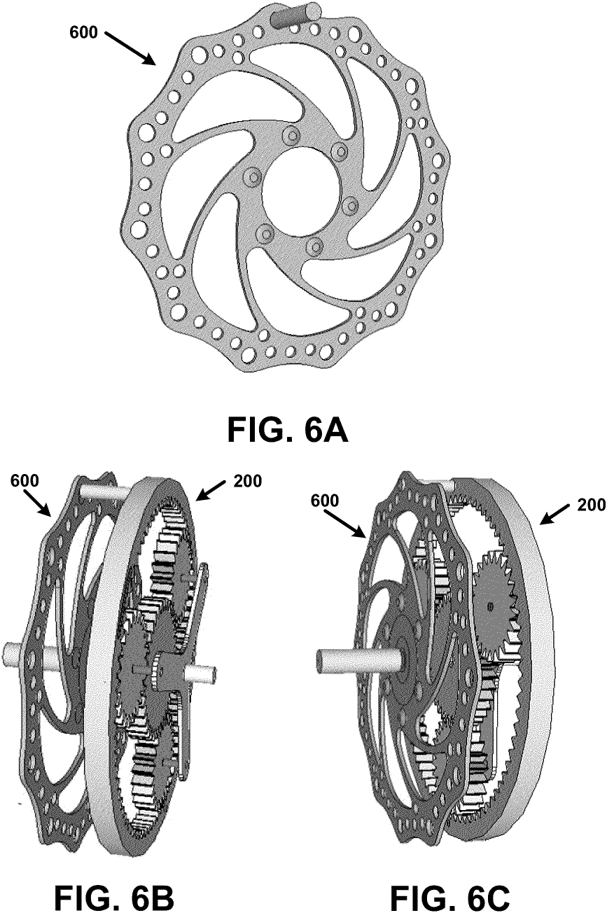

FIG. 6A shows for illustrative purposes only an example of a lobed disc of one embodiment. FIG. 6A shows a lobed disc 600 used in transferring kinetic energy from, for example, a wheel to a planetary gear set of one embodiment.

FIG. 6B shows for illustrative purposes only an example of a lobed disc coupled to a planetary gear set from the gear set perspective of one embodiment. FIG. 6B shows a lobed disc 600 coupled to a planetary gear set from the gear set perspective. The lobed disc, when speed and force are applied to the lobed disc, transfers kinetic energy with a rod coupled to the ring gear of the planetary gear set of one embodiment.

FIG. 6C shows for illustrative purposes only an example of a lobed disc coupled to a planetary gear set from the lobed disc perspective of one embodiment. FIG. 6C shows a lobed disc 600 coupled to a planetary gear set from the lobed disc perspective. A rotating lobed disc transfers the speed and force of its rotation to the ring gear. In one instance the speed and force energy transferred to the ring gear is further transferred to the flywheel of one embodiment.

### Planetary Gear Set Movement

FIG. 7 shows for illustrative purposes only an example of a planetary gear set movement of one embodiment. FIG. 7 shows planetary gear set movement when speed and force of kinetic energy are transferred for a primary energy source. Seen are the different movements when the input is moving. The input in this instance is the primary kinetic source, for example, a gas engine 102 turning in this example in a gas engine clockwise direction 700. The primary kinetic source energy is transferred to the sun gear 220 of FIG. 2 which rotates also in a sun gear clockwise direction 710. The sun gear clockwise direction 710 is transferred to each carrier gear 240 of FIG. 2 that rotates in a carrier gear counterclockwise direction 720.

The carrier gear counterclockwise direction 720 rotates the ring gear 210 of FIG. 2 in a ring gear counterclockwise direction 730. Each carrier gear 240 of FIG. 2 is coupled to the planetary carrier 230 of FIG. 2 that remains stationary. The CVT kinetic force is input into the sun gear and that force is split between the ring gears. The CVT is the speed governor, and the carrier is the output. The speed/force minus the speed/force to the ring gear equals the speed/force that exits the carrier shaft 750. The carrier gears move the carrier and do not enter the equation.

The force/speed can enter through the input/sun gear 220 of FIG. 2 or through the carrier shaft 750 when a car is decelerating. The ring gear controls which direction that force/speed goes, either into the ring gear or to the sun gear. When the CVT is connected to a Flywheel storage device, the energy can either come from it through the sun gear 220 of FIG. 2 or can be input back into it through the same gear. Depending on if the auto is accelerating or decelerating of one embodiment.

### Primary Kinetic Source Combustion Engines on Automobiles

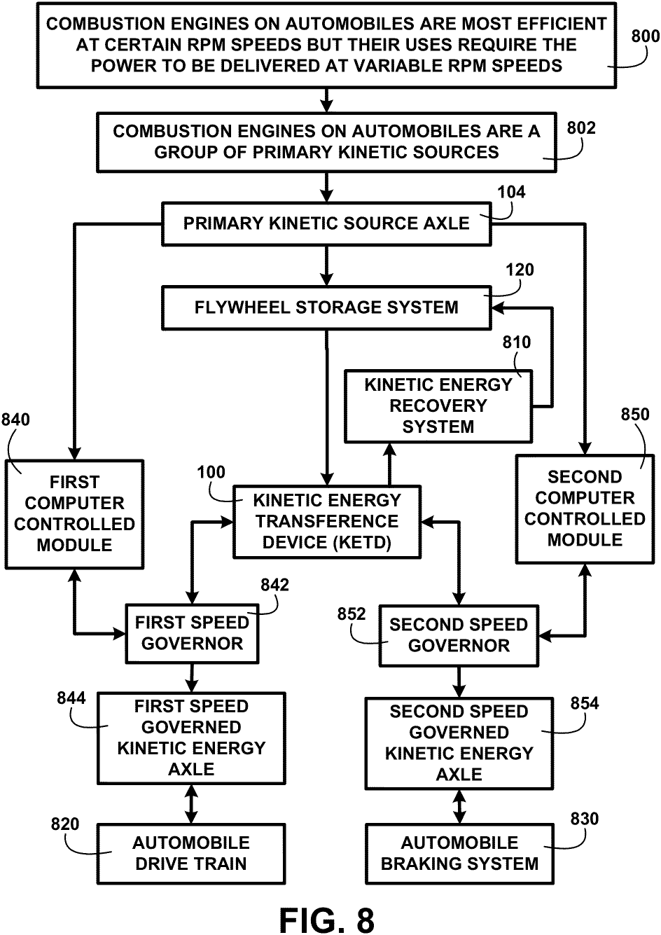

FIG. 8 shows a block diagram of an overview of primary kinetic source combustion engines on automobiles of one embodiment. FIG. 8 shows combustion engines on automobiles are most efficient at certain rpm speeds, but their uses require the power to be delivered at variable rpm speeds 800. In one embodiment combustion engines on automobiles are a group of primary kinetic sources 802. A primary kinetic source axle 104 is coupled to a flywheel storage system 120. A flywheel is used for a kinetic energy transference device (KETD) 100 in a kinetic energy recovery system 810.

A first computer-controlled module 840 is electronically coupled to a first-speed governor 842. The first-speed governor 842 is coupled to the kinetic energy transference device (KETD) 100 and to a first-speed governed kinetic energy axle 844. The first speed-governed kinetic energy axle 844 is coupled to an automobile drive train 820 and is a mechanism to control the rate of speed of the automobile drive train 820.

A second computer-controlled module 850 is electronically coupled to a second-speed governor 852. The kinetic energy recovery system 810 determines any excess kinetic energy not needed by the automobile drive train 820. The excess kinetic energy determined is passed through to a second speed-governed kinetic energy axle 854 for transference to an automobile braking system 830 of one embodiment.

### Primary Kinetic Source Electric Motor/Generator

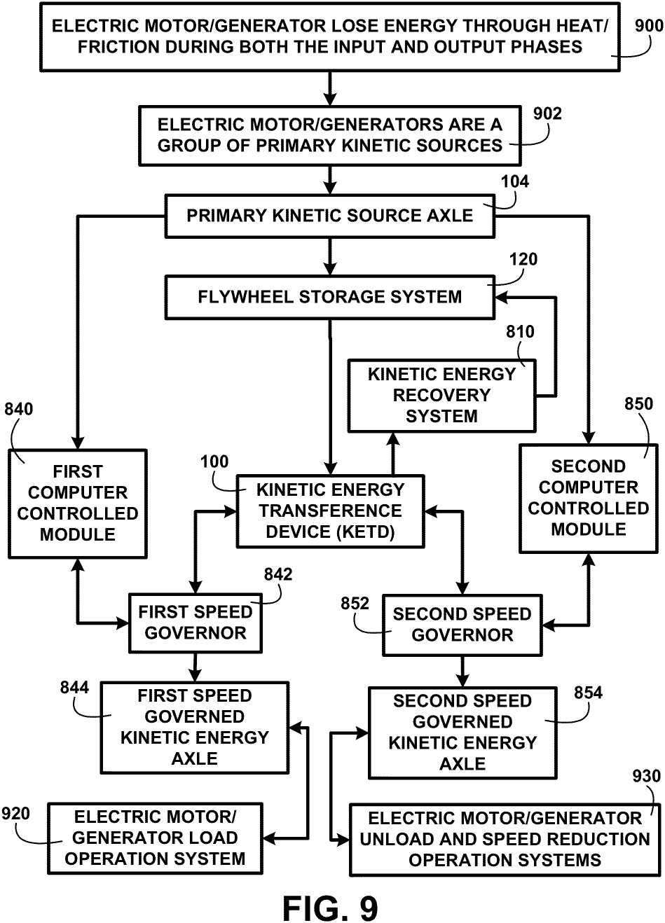

FIG. 9 shows a block diagram of an overview of the primary kinetic source electric motor/generator of one embodiment. FIG. 9 shows electric motor/generator loses energy through heat/friction during both the input and output phases 900. In one embodiment electric motors/generators are a group of primary kinetic sources 902. A primary kinetic source axle 104 is coupled to a flywheel storage system 120. A flywheel is used for a kinetic energy transference device (KETD) 100 in a kinetic energy recovery system 810.

A first computer-controlled module 840 is electronically coupled to a first-speed governor 842. The first-speed governor 842 is coupled to the kinetic energy transference device (KETD) 100 and to a first-speed governed kinetic energy axle 844. The first speed-governed kinetic energy axle 844 is coupled to an electric motor/generator load operation system 920 and is a mechanism to control the rate of speed of the electric motor/generator load operation system 920.

A second computer-controlled module 850 is electronically coupled to a second-speed governor 852. The kinetic energy recovery system 810 determines any excess kinetic energy not needed by the electric motor/generator load operation system 920. The excess kinetic energy determined is passed through to a second speed-governed kinetic energy axle 854 for transference to an electric motor/generator unload and speed reduction operation systems 930 of one embodiment.

### Primary Kinetic Source Devices With Large Starting Energy Demands

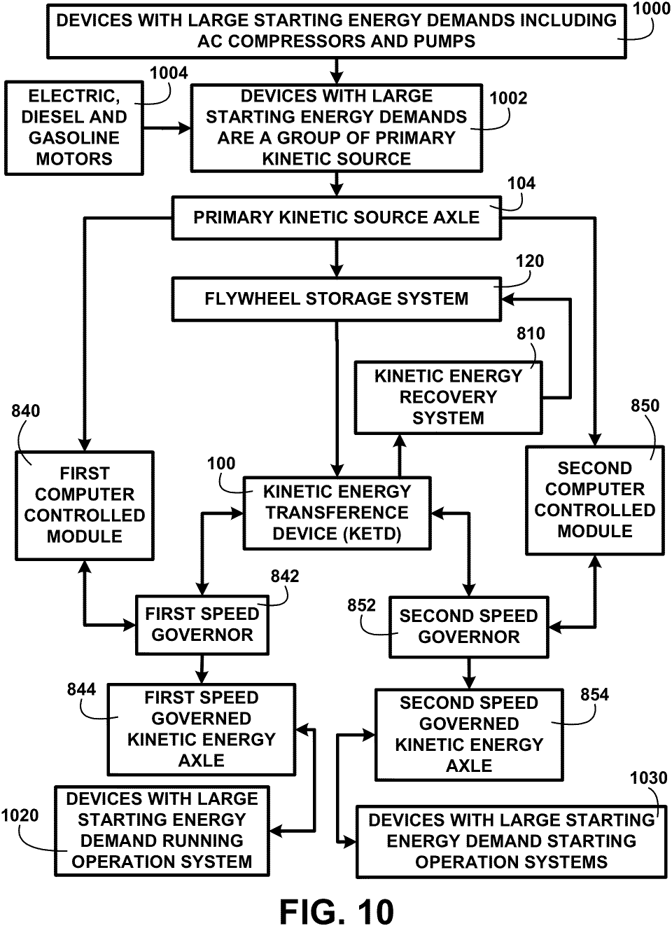

FIG. 10 shows a block diagram of an overview of primary kinetic source devices with large starting energy demands of one embodiment. FIG. 10 shows devices with large starting energy demands including ac compressors and pumps 1000 and electric, diesel, and gasoline motors 1004. In one embodiment devices with large starting energy demands are a group of primary kinetic sources 1002. A primary kinetic source axle 104 is coupled to a flywheel storage system 120. A flywheel is used for a kinetic energy transference device (KETD) 100 in a kinetic energy recovery system 810.

A first computer-controlled module 840 is electronically coupled to a first-speed governor 842. The first-speed governor 842 is coupled to the kinetic energy transference device (KETD) 100 and to a first-speed governed kinetic energy axle 844. The first speed-governed kinetic energy axle 844 is coupled to devices with large starting energy demand running operation system 1020 and is a mechanism to control the rate of speed of the devices with large starting energy demand running operation system 1020.

A second computer-controlled module 850 is electronically coupled to a second-speed governor 852. The kinetic energy recovery system 810 determines any excess kinetic energy not needed by the devices with large starting energy demand running operation system 1020. The excess kinetic energy determined is passed through to a second speed-governed kinetic energy axle 854 for transference to devices with large starting energy demand starting operation systems 1030 of one embodiment.

### A Primary Kinetic Source

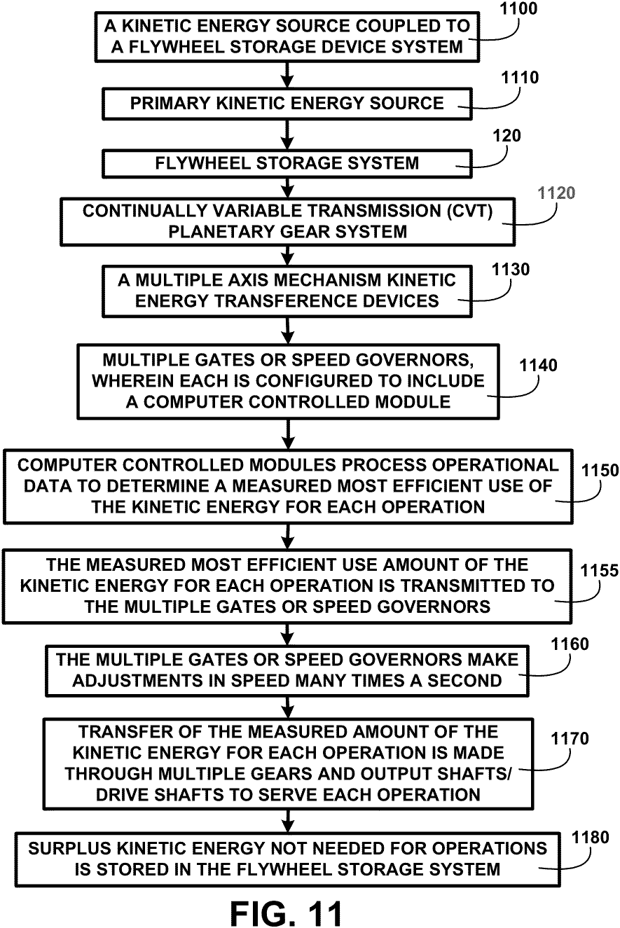

FIG. 11 shows for illustrative purposes only an example of a primary kinetic source of one embodiment. FIG. 11 shows a kinetic energy source coupled to a flywheel storage device system 1100. The primary kinetic energy source 1110 supplies energy in the form of speed and force that in part may be stored in the flywheel storage system 120. A continually variable transmission (CVT) planetary gear system 1120 is a multiple-axis mechanism kinetic energy transference device 1130. The continually variable transmission (CVT) planetary gear system 1120 includes multiple gates or speed governors, wherein each is configured to include a computer-controlled module 1140.

Computer-controlled modules process operational data to determine the measured most efficient use of energy for each operation 1150. The measured most efficient use amount of the kinetic energy for each operation is transmitted to the multiple gates or speed governors 1155. The multiple gates or speed governors make adjustments in speed many times a second 1160. Transfer of the measured amount of the kinetic energy for each operation is made through multiple gears and output shafts/drive shafts to serve each operation 1170. Surplus kinetic energy not needed for operations is stored in the flywheel storage system 1180 of one embodiment.

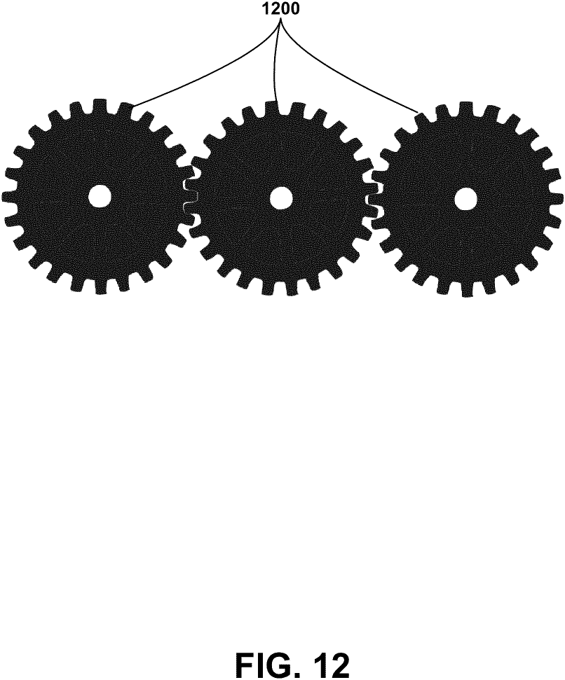

FIG. 12 shows for illustrative purposes only an example of a transfer gears of one embodiment. FIG. 12 shows in one embodiment transfer gears 1200 are aligned side to side whereas in another embodiment the transfer gears are configured in a triangular orientation of one embodiment.

### A Hydraulic Actuator 1300 Coupled to a Lobed Disc

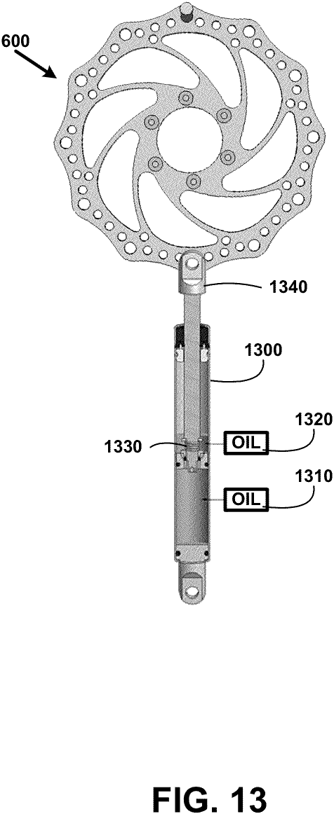

FIG. 13 shows for illustrative purposes only an example of a hydraulic actuator coupled to a lobed disc of one embodiment. FIG. 13 shows a hydraulic actuator 1300 coupled to a lobed disc 600 to transfer kinetic energy. The hydraulic actuator 1300 is also used as a shock absorber in autos. There is a valve 1330 at the end of rod 1340 inside the chamber which controls the amount of fluid in this instance oil that can pass from beneath rod 1310 to the area around rod 1320. By adjusting this valve, the force needed to move the rod up or down becomes easier or harder. To act as a speed governor, this actuator connects to a wheel bearing that rides on the outer edge of the lobed disc 600.

As the disc above rotates, the lobes on the disc cause the actuator to go in and out. By controlling valve 1330 in the actuator 1300, the force needed for the disc to turn increases or decreases. The greater the force applied to the actuator 1300, the equal amount of force exits the carrier of the CVT, and the speed goes with it. This actuator valve can be controlled electronically and adjusted to direct the desired speed or force out the carrier shaft 750 of FIG. 7. The CVT control module takes input from the speed entering the CVT, the force that is being applied, the desired speed and force being called for, and the current speed force exiting the output/carrier shaft 750 of FIG. 7 of one embodiment.

### Hybrid Automobile Regenerative Brakes

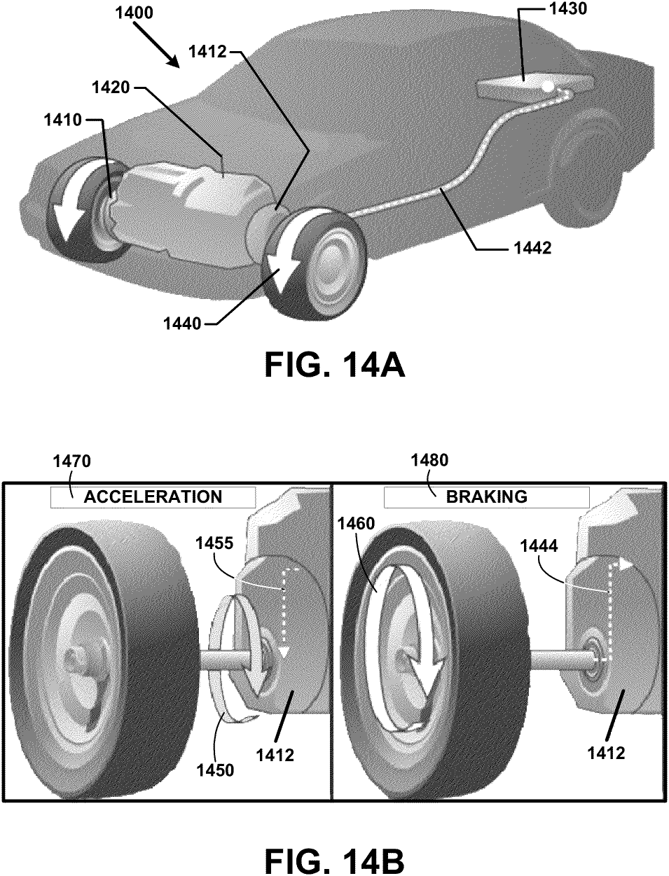

FIG. 14A shows for illustrative purposes only an example of a hybrid automobile regenerative brakes of one embodiment. FIG. 14A shows a hybrid automobile with regenerative brakes 1400. A right electric motor 1410 and at times a gasoline engine 1420 and a left electric motor 1412 provide power to the front wheels. Kinetic brake energy 1440 is developed when decelerating or stopping.

The kinetic brake energy 1440 is fed back to the battery 1430. The kinetic energy transference device 100 of FIG. 1 reduces the energy consumed for actual deceleration and stopping and transfers the increased recovered braking energy 1442 to the battery 1430 of one embodiment.

FIG. 14B shows for illustrative purposes only an example of acceleration and braking for hybrid automobile regenerative brakes of one embodiment. FIG. 14B shows in the left panel an example of acceleration 1470. In this example, acceleration 1470 is powered by the left electric motor 1412. Acceleration energy 1450 is supplemented using the stored kinetic energy from the kinetic energy transference device 100 of FIG. 1 thereby reducing the acceleration energy from the left electric motor 1455 of one embodiment.

The right panel shows braking 1480 wherein energy from the left electric motor 1412 is conserved in part and kinetic brake energy 1460 is generated. The kinetic energy transference device 100 of FIG. 1 provides a portion of the braking energy needed reducing the energy needed to decelerate and increasing the recovered braking energy that is transferred 1444 to the battery 1430 of one embodiment.

### Acceleration Kinetic Energy Flow

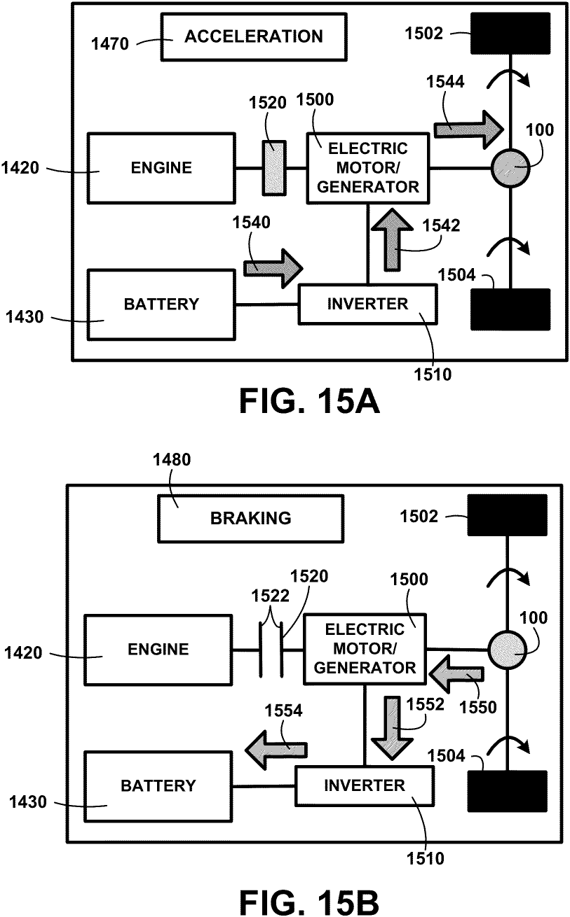

FIG. 15A shows for illustrative purposes only an example of the acceleration kinetic energy flow of one embodiment. FIG. 15A shows how kinetic energy flows, for example, in an automobile during acceleration 1470. Kinetic energy from an engine 1420 is transferred to a clutch 1520 to an electric motor/generator 1500. Additional energy is transferred 1540 from a battery 1430 to an inverter 1510 and transferred 1542 to the electric motor/generator 1500. The combined energy is transferred 1544 to the kinetic energy transference device 100 and split a left drive wheel 1502 and a right drive wheel 1504 of one embodiment.

### Braking Kinetic Energy Flow

FIG. 15B shows for illustrative purposes only an example of the braking kinetic energy flow of one embodiment. FIG. 15B shows how kinetic energy flows, for example, in an automobile during braking 1480. Kinetic energy from an engine 1420 is not transferred 1522 through the clutch 1520 to an electric motor/generator 1500. The kinetic energy generated is transferred 1550 from the left wheel 1502 and right wheel 1504 through the kinetic energy transference device 100. The braking energy generated is converted to electricity in the electric motor/generator 1500. The converted electricity is transferred 1552 to the inverter 1510. The inverter 1510 regulates the characteristics of the electrical energy and transfers 1554 to the battery 1430 of one embodiment.

The CVT can recover as much energy as it can deliver as that limit is set by the gate or speed governor 500 of FIG. 5 and it doesn’t matter in which direction the energy is flowing. In and out requires the same mechanics so for the same cost to be able to recover 1500 horsepower, the CVT can supply that much power too. If the specifications are for the CVT to be able to recover 1500 horsepower, then it can deliver that much too, and for no additional costs. If the flywheel and CVT can handle 1500 HP input, it can also deliver that much power if desired and for no additional cost.

### Additional Applications and Features

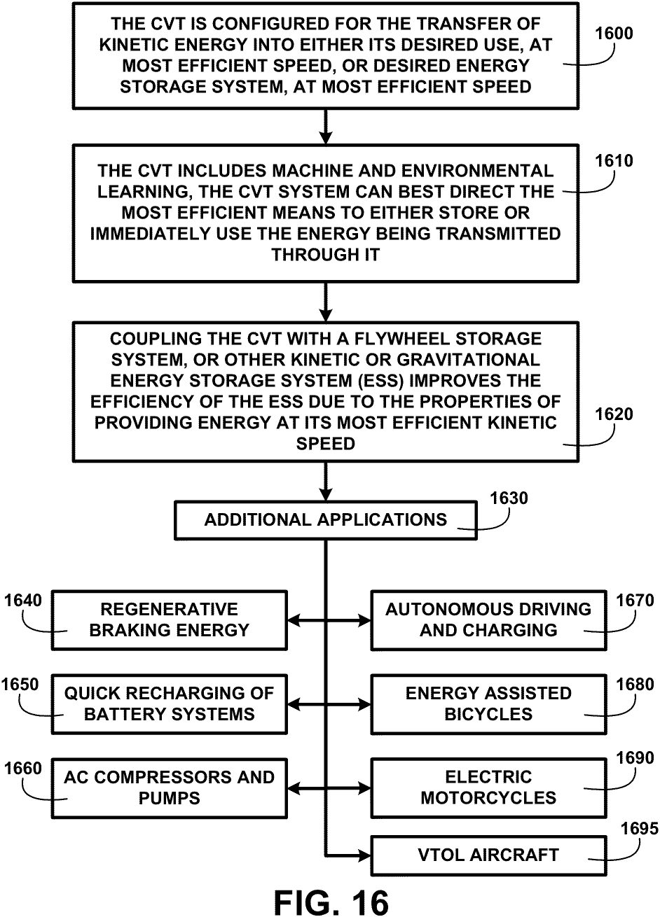

FIG. 16 shows a block diagram of an overview of additional applications and features of one embodiment. FIG. 16 shows additional applications and features of the kinetic energy transference device 100 of FIG. 1. The CVT is configured for the transfer of kinetic energy into its desired use, at the most efficient speed, or desired energy storage system, at the most efficient speed 1600.

The CVT includes machine and environmental learning, the CVT system can best direct the most efficient means to either store or immediately use the energy being transmitted through it 1610. Coupling the CVT with a flywheel storage system, or other kinetic or gravitational energy storage system (ESS) improves the efficiency of the ESS due to the properties of providing energy at its most efficient kinetic speed 1620.

The kinetic energy transference device 100 of FIG. 1 has additional applications 1630 other than automobiles. As described regenerative braking energy 1640 of vehicles and equipment that starts and stops recover energy that can reduce starting energy with the stored energy being applied to starting motors to reduce costs, wear and tear of motors, and save time by shorting the start-up period.

Quick recharging of battery systems 1650 is achieved by applying the stored energy in the recharging system on top of the other energy sources. Reducing start-up time with stored energy augmenting normal power consumption also reduces stress on motors of AC compressors and pumps 1660.

Autonomous driving and charging 1670 is improved by reducing energy consumption and applying stored and recovered energy to extend driving time and distance. An autonomous auto can drive itself to the nearest most efficient charging station at times is not desirable for most humans. Using the CVT and its learning systems, the auto can locate, calculate and arrive at the most efficient location to recharge its energy storage systems. At the charging station, the CVT system can determine and direct the energy into the most efficient storage system.

Riders of energy-assisted bicycles 1680 do not need to work as hard as the kinetic energy transference device 100 of FIG. 1 will apply stored and recovered energy to add non-rider exerted effort to power the energy-assisted bicycles 1680. Most energy-assisted bicycles use electric motors and chemical batteries to assist. These systems are charged at home and recover energy during their use. Instead of using electric motors and batteries, they can employ the CVT with flywheel storage. Keeping kinetic energy in its form is more efficient than transferring it to and from chemical storage systems. A CVT bicycle system can provide greater range and less weight than other battery/electric systems. Additionally, a CVT with a flywheel bicycle system can convert energy from its rider, through a crank system, to continually collect energy at a desired rate but deliver energy as needed such as the increase in the amount of energy needed for steep inclines.

The same is true for electric motorcycles 1690 with reducing energy consumption and applying stored and recovered energy to extend driving time and distance. Because the CVT can very efficiently transmit kinetic energy, systems using weights can be more efficient when employing the CVT to transmit the kinetic energy from the gravitational pull to the electrical generator. The same works in reverse for converting electricity to lift the weight again. In systems like windmills and hydro plants, keeping the energy in kinetic form is more efficient. Utilizing the CVT will increase the net amount of energy from a system by decreasing the amount of loss of energy during the charging and discharging phases. With machine learning, utilizing the CVT to direct where to store the energy will also increase the system’s net efficiency.

The main use of energy for VTOL aircraft 1695 and most aircraft is to get the craft airborne. Current flywheel technology allows more energy density than batteries so using flywheels, coupled with the CVT, can provide better efficiency for the new wave of VTOL and electric aircraft. The high demands of energy for lifting an aircraft into flight mode can be better handled by drawing that energy from flywheels rather than batteries. This lessen the weight needed if that energy had to come from batteries. Most current aircraft designs do not recover energy in the slowing down and landing portions of their flight. With the CVT, prior to landing, the craft can recover energy during the slow down and descent phases of the flight and store that energy in the flywheels to use again during the vertical landing phases. During traditional flights, during the slow down and descent portion of the flight, the aircraft bleeds off speed gradually. This means the energy is being consumed by friction and not recovered. Our CVT will shorten this phase and recover the energy to use during the final landing phase. This will decrease the total flight time and allow passengers to reach their destination quicker and with less total energy needed of one embodiment.

### Multiple Axis Mechanism

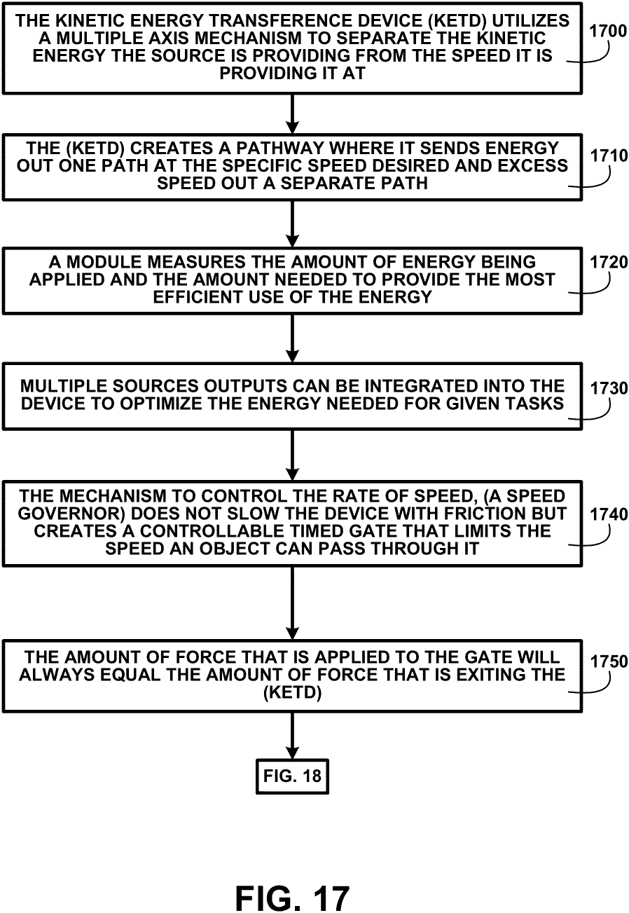

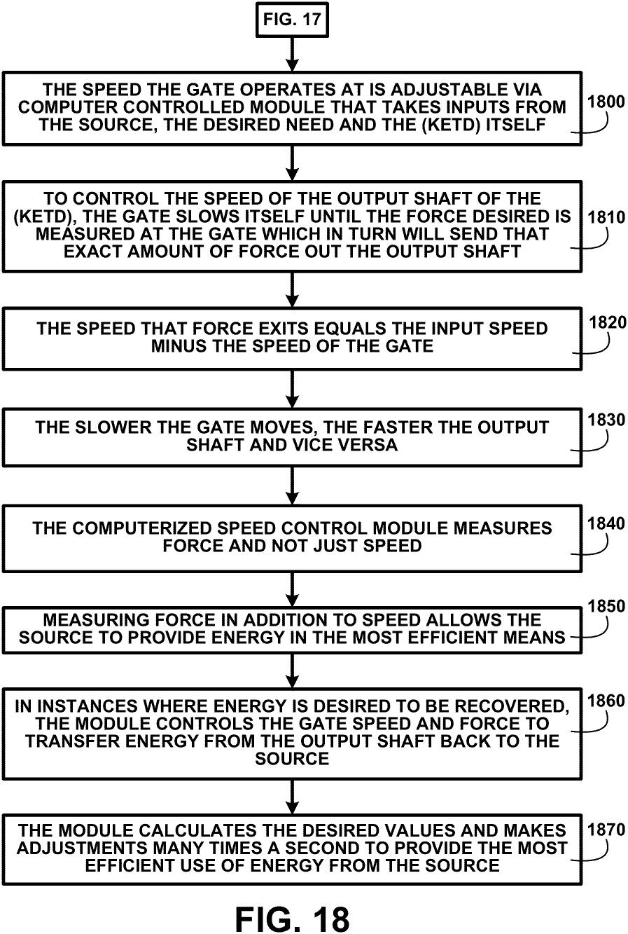

FIG. 17 shows a block diagram of an overview of a multiple-axis mechanism of one embodiment. FIG. 17 shows the kinetic energy transference device (KETD) utilizes a multiple-axis mechanism to separate the kinetic energy the source is providing from the speed it is providing at 1700. The (KETD) creates a pathway where it sends energy out of one path at the specific speed desired and excess speed out to a separate path 1710. A module measures the amount of energy being applied and the amount needed to provide the most efficient use of the energy 1720. Multiple sources of outputs can be integrated into the device to optimize the energy needed for given tasks 1730. The mechanism to control the rate of speed, (a speed governor) does not slow the device with friction but creates a controllable timed gate that limits the speed an object can pass through it 1740. The amount of force that is applied to the gate will always equal the amount of force that is exiting the (KETD) 1750 of one embodiment. The descriptions continue in FIG. 18.

### KETD Features

FIG. 18 shows a block diagram of an overview of the KETD features of one embodiment. FIG. 18 shows a continuation from FIG. 17 with the speed the gate operates is adjustable via a computer-controlled module that takes inputs from the source, the desired need, and the (KETD) itself 1800. To control the speed of the output shaft of the (KETD), the gate slows itself until the force desired is measured at the gate which in turn will send that exact amount of force out of the output shaft 1810. The speed that forces exits equals the input speed minus the speed of the gate 1820. The slower the gate moves, the faster the output shaft and vice versa 1830.

The computerized speed control module measures force and not just speed 1840. Measuring force in addition to speed allows the source to provide energy in the most efficient means 1850. In instances where energy is desired to be recovered, the module controls the gate speed and force to transfer energy from the output shaft back to the source 1860. The module calculates the desired values and makes adjustments many times a second to provide the most efficient use of energy from the source 1870 of one embodiment.

### A Computer Application

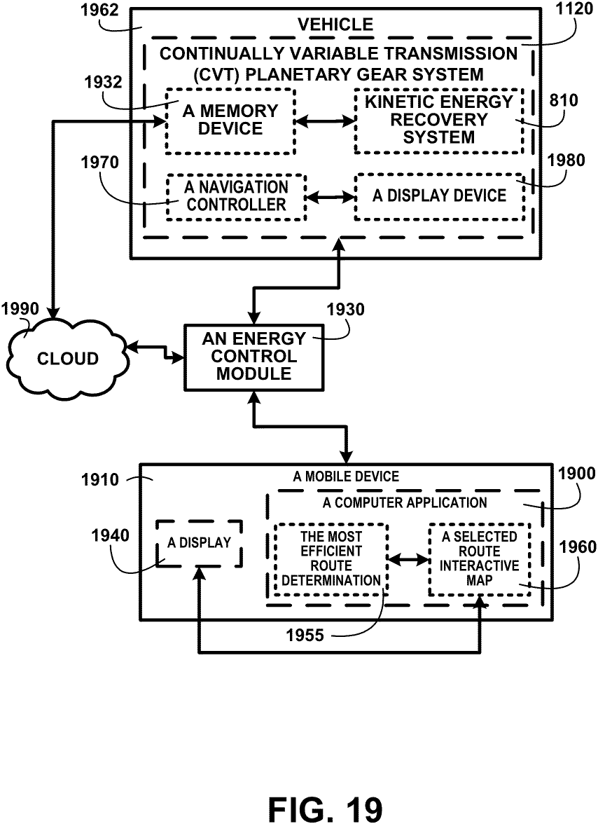

FIG. 19 shows a block diagram of an overview of a computer application of one embodiment. FIG. 19 shows a vehicle 1962 coupled to a continually variable transmission (CVT) planetary gear system 1120. The continually variable transmission (CVT) planetary gear system 1120 includes a kinetic energy recovery system 810. The continually variable transmission (CVT) planetary gear system 1120 includes a memory device 1932, a navigation controller 1970, and a display device 1980. The memory device 1932 stores vehicle specification, the current cost of fuel, energy volumes being consumed, and quantities of regenerated energy recovered. A cloud 1990 is coupled to the memory device 1932. The cloud 1990 is also coupled to an energy control device 1930. The energy control device 1930 is also coupled to a mobile device 1910. The mobile device 1910 includes a computer application 1900. The computer application 1900 includes data for a most efficient route determination 1955. The computer application 1900 displays a selected route interactive map 1960 on a display 1940. The selected route interactive map 1960 shows the vehicle’s GPS location on the interactive map image to guide the driver along the selected route.

In one embodiment a computer application operating on a mobile device is wirelessly coupled to the continuously variable transmission configured to collect and store on a cloud device vehicle specification, the current cost of fuel, energy volumes being consumed, and quantities of regenerated energy recovered 1900. A user accesses a computer application regarding the user’s vehicle details and current cost of fuel or energy. Fuel or energy may include gasoline, diesel, electricity, H20, or other sources of energy.

Information is gathered from other sources regarding current traffic patterns, weather, and other data that could factor into the computation of costs for a trip. The user enters the destination they desire to transit to. The system identifies the different routes that can be used. The system calculates the estimated costs and timing for each of the different routes.

The computer application displays the different routes, the time that it should take, and the costs for each route. The user can select which route they desire to take. The selection includes the fastest route, cheapest energy route, or a mix of both. The user can either have the vehicle self-drive, if that is an option, or be guided along the route to the destination. Wherein the computer application is further configured to collect information regarding current traffic patterns, maps, weather, and other data factored into an analysis of costs for a trip to a user-selected destination 1910.

A continuously variable transmission coupled to a motor vehicle is configured to recover regenerated energy produced by the continuously variable transmission 1920. An energy control device coupled to the cloud is configured to analyze the cloud-stored data including vehicle specifications, the current cost of fuel and energy volumes being consumed, quantities of regenerated energy recovered, current traffic patterns, maps, weather, and other data factors to determine travel times and a net amount of energy used less the amount of energy regenerated 1930.

The system can also have numerous cameras located at various locations on the vehicle. A display device on the mobile device and/or the vehicle, including a screen in a vehicle and/or on a mobile phone, can display live images from the vehicle cameras and/or the mobile phone camera as augmented reality (AR) image. AR and/or virtual reality (VR) glasses, or other AR or VR devices can be used with an interactive map of the AR and/or VR images. At least one selected route can be visibly displayed and viewed by the user 1940. A selected route interactive map image is visibly displayed on a display device showing the vehicle’s GPS location on the interactive map image to guide the driver.

A program module coupled to a vehicle is configured to display and guide the driver along the most efficient route between two or more destinations 1950. The most efficient route is typically a route that has the shortest travel time and an estimated cost within a predefined range 1955. A selected route interactive map image visibly displayed on a display device can show the vehicle’s GPS location on the interactive map image to guide the driver 1960. A navigation controller of an autonomous self-driving vehicle is coupled to the program module configured to receive the selected route GPS coordinates to guide the vehicle along the selected route 1970 to the destination.

In another embodiment, a continuously variable transmission system for a vehicle includes a continuously variable transmission with plural sensors and is configured to collect vehicle data comprising data vehicle specifications, current cost of fuel, energy volumes being consumed, and quantities of regenerated energy recovered. An energy control device coupled to the plural sensors is configured to analyze the vehicle data to determine a net amount of energy used less the amount of energy regenerated, a preferred travel route and an estimated cost within a predefined range between a user selected first location and at least two other user selected destinations. A navigation controller coupled to the energy control device is configured to navigate the vehicle along the preferred travel route. A display device coupled to the navigation controller is configured to display the estimated cost and the preferred travel route in real-time on an interactive map. A mobile device wirelessly coupled to the energy control device and the navigation controller is configured to display the estimated cost and the preferred travel route in real-time and allow the user to alter the preferred travel route.

This system includes a route cost device coupled to the program module configured to determine if the cost of the travel is worth an anticipated financial gain from the trip, for example, for use by Transportation-as-a-Service (TaaS) drivers (Uber, Lyft, etc.) to help determine if the price being offered is worth accepting a ride. This system can be used by delivery drivers and dispatchers to help determine the most efficient or quickest routes for one or more deliveries. This system can be used by commuters to help determine the most efficient route or time to drive to work. To navigate, guide, and display users’ properties that they may be interested in acquiring or utilizing in some manner. A GPS device to keep track of the location of the vehicle if one is not already accessible on the vehicle. A device can be installed to input and/or collect data such as property details (Photos, videos, specifications), vehicle details (cost, specifications, etc.), and other data that may be relevant in computing costs and usage of energy to transit between locations.

A marketplace can be coupled to the system where property details are hosted and displayed to parties looking to acquire or utilize such and a payment system to manage the transfer of value for transactions in the marketplace. In this embodiment, a user accesses the marketplace via a mobile app or web portal. The user inputs the data regarding the type of property they are looking to acquire or utilize in some manner. The system searches through its database and other available data to identify properties that meet the user’s criteria and compile a list. The user selects which properties they are interested in.

The system plots a course for the different properties. The vehicle can either self-drive to these locations or the user can manually drive and be guided by the system. As the user nears each location, the user can view further details of the properties such as images, videos, virtual tours, or other data that would be relevant. The system can also provide data such as the average cost to commute to work from a selected property. If the user selects a property they wish to acquire or utilize in some fashion, the system can handle the financial aspects of the transaction including document signing and payments. Homebuyers can more easily, and on their time frame, locate and view potential properties without the need for realtors or other parties and without disturbing the current homeowners.

A system for automated and manually driven vehicles is configured to find the most efficient charging stations. For vehicles without the continuously variable transmission, a program module calculates the energy aspects of a vehicle, wherein both use and recovery can be installed. A device to input and/or collect data such as energy cost, temperature, humidity, vehicle details, cost, specifications, etc., and other data that may be relevant in computing costs and usage of energy. An internet connection can be installed to pull data from charging stations regarding their locations, prices, and availability, and a GPS device can be used to keep track of the location of the vehicle.

The autonomous vehicle, including an automobile, aircraft, or other motorized vehicles, can continuously pull data from nearby charging stations. The system monitors the vehicle’s energy supply to calculate the most efficient time to recharge. The system calculates distances and costs to recharge at the available charging station. The system keeps track of normal operations to determine the best times when the vehicle will not be needed in order to schedule a time to recharge.

The system can identify the best place and time to recharge when in autonomous mode. During this mode, the vehicle will navigate to the charging station, recharge, and return. When the system identifies the best place and time to recharge when in manual-driven mode, it will alert the driver of the different options. The driver will select the best option and be guided to the charging station, recharge, and return.

The costs to recharge are different and this system calculates the most efficient means to recharge. If the costs are less at a farther away location, the savings may not justify the distance needed to travel to get to that location. The system keeps track of energy usage and the planned routes to determine when and where to recharge. Delivery vehicles and fleets can benefit from the most efficient times and locations to recharge given their routes and times of operation.

In one embodiment, a continuously variable transmission coupled to a user’s vehicle is configured to recover regenerated energy produced by the continuously variable transmission. A computer application on a user’s mobile device wirelessly coupled to the continuously variable transmission configured to collect and store on a cloud device a user’s vehicle details, the current cost of fuel and energy volumes being consumed, and quantities of regenerated energy recovered. An energy control device coupled to the cloud device is configured to compute and charge the current cost of fuel or energy for a net amount of energy used less than the amount of energy regenerated.

A program module coupled to the energy control device is configured to display and guide the user along the shortest travel time and cost-efficient route between a user’s location and two or more user-selected destinations. An autonomous self-driving vehicle coupled to the program module configured to be guided by the program module along the most efficient route to the destination. A vehicle manually driven coupled to the program module configured to guide the user along the displayed most efficient route GPS coordinates to the destination of one embodiment.

### An Energy Control Module

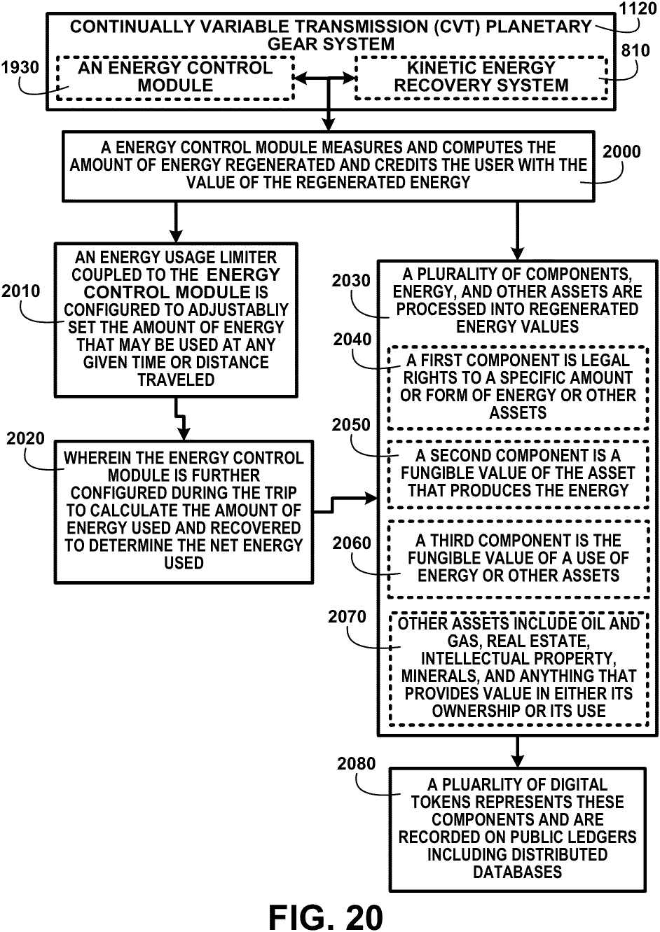

FIG. 20 shows a block diagram of an overview of an energy control module of one embodiment. FIG. 20 shows the continually variable transmission (CVT) planetary gear system 1120 including an energy control module 1930 and the kinetic energy recovery system 810. The energy control module is measuring and computing the amount of energy regenerated and credits the user with the value of the regenerated energy 2000. The credits are used to fractionalize and monetize the use and recovery of energy. The process is used to compute and charge for the net amount of energy used less than the amount regenerated. The continuously variable transmission, through its control module, measures the amount of energy demanded by the user and delivers it through the continuously variable transmission.

An energy usage limiter coupled to the energy control module is configured to adjustably set the amount of energy that may be used at any given time or distance traveled 2010. The owner enters the web portal for the control module and places limits and sets parameters for the energy used for their vehicle. Wherein the energy control module is further configured during the trip to calculate the amount of energy used and recovered to determine the net energy used 2020.

A plurality of components, energy, and other assets are processed into regenerated energy values 2030. The first component is legal rights to a specific amount or form of energy or other assets 2040. A second component is the fungible value of the asset that produces the energy 2050. A third component is the fungible value of the use of energy or other assets 2060. Other assets include oil and gas, real estate, intellectual property, minerals, and anything that provides value in either its ownership or its use 2070. A plurality of digital tokens represents these components and are recorded on public ledgers including distributed databases 2080 of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A continuously variable transmission system for a vehicle, comprising:
a continuously variable transmission with plural sensors configured to collect vehicle data comprising vehicle specifications, current cost of fuel, consumed energy volumes, and quantities of regenerated energy recovered;
an energy control module coupled to the plural sensors and configured to analyze the vehicle data to determine a net amount of energy used less an amount of energy regenerated, a preferred travel route between a user selected first location and at least two other user selected destinations and an estimated cost for the vehicle to travel on the preferred travel route;
a navigation controller coupled to the energy control module and configured to navigate the vehicle along the preferred travel route;
a display device coupled to the navigation controller and configured to display the estimated cost and the preferred travel route in real-time on an interactive map; and
a mobile device wirelessly coupled to the energy control module and the navigation controller and configured to display on the mobile device in real time the estimated cost and the preferred travel route and to allow the user to alter the preferred travel route.

2. The continuously variable transmission system for a vehicle of claim 1, wherein the plural sensors are further configured to collect information relating to current traffic conditions and weather data.

3. The continuously variable transmission system for a vehicle of claim 1, wherein the mobile device includes a camera configured to capture a live image and superimpose an augmented reality image on the mobile device in real time.

4. The continuously variable transmission system for a vehicle of claim 1, wherein the display device displays alternative routes and travel times and costs associated with each alternate route.

5. The continuously variable transmission system for a vehicle of claim 1, wherein the energy control module is further configured to compare a cost associated with the preferred travel route to an anticipated financial gain of the preferred travel route.

6. The continuously variable transmission system for a vehicle of claim 1, further comprising a plurality of digital tokens coupled to the mobile device representing recovered regenerated energy value components and recorded on public ledgers including distributed databases.

7. The continuously variable transmission system for a vehicle of claim 1, wherein the continuously variable transmission is further configured to collect information on charging station locations, charging station prices and charging station availability.

8. The continuously variable transmission system for a vehicle of claim 1, wherein the continuously variable transmission further includes a camera configured to capture a live image and wherein the display device is configured to superimpose an augmented reality image on the display device in real time.

9. A continuously variable transmission system for a vehicle, comprising:
a continuously variable transmission with plural sensors configured to collect vehicle data comprising vehicle specifications, current cost of fuel, consumed energy volumes, quantities of regenerated energy recovered and charging station locations, charging station prices and charging station availability;
an energy control module coupled to the plural sensors and configured to analyze the vehicle data to determine a net amount of energy used less an amount of energy regenerated, a preferred travel route between a user selected first location and at least two other user selected destinations and an estimated cost for the vehicle to travel on the preferred travel route;
a navigation controller coupled to the energy control module and configured to navigate the vehicle along the preferred travel route;
a display device coupled to the navigation controller and configured to display the estimated cost and the preferred travel route in real-time on an interactive map; and
a mobile device wirelessly coupled to the energy control module and the navigation controller and configured to display on the mobile device in real time the estimated cost and the preferred travel route and to allow the user to alter the preferred travel route.

10. The continuously variable transmission system for a vehicle of claim 9, further comprising a plurality of digital tokens coupled to the mobile device representing recovered regenerated energy value components and recorded on public ledgers including distributed databases.

11. The continuously variable transmission system for a vehicle of claim 9, wherein the energy control module is further configured to compare a cost associated with the preferred travel route to an anticipated financial gain of the preferred travel route.

12. The continuously variable transmission system for a vehicle of claim 9, wherein the mobile device includes a camera configured to capture a live image and superimpose an augmented reality image on the mobile device in real time.

13. The continuously variable transmission system for a vehicle of claim 9, wherein the continuously variable transmission further includes a camera configured to capture a live image and wherein the display device is configured to superimpose an augmented reality image on the display device in real time.

14. The continuously variable transmission system for a vehicle of claim 9, wherein the display device displays alternative routes and travel times and costs associated with each alternate route.

15. A continuously variable transmission system for a vehicle, comprising:
a continuously variable transmission with plural sensors configured to collect vehicle data comprising vehicle specifications, current cost of fuel, consumed energy volumes, and quantities of regenerated energy recovered;
an energy control module coupled to the plural sensors and configured to analyze the vehicle data to determine a net amount of energy used less an amount of energy regenerated, a preferred travel route between a user selected first location and at least two other user selected destinations and an estimated cost for the vehicle to travel on the preferred travel route, wherein the energy control module is further configured to compare a cost associated with the preferred travel route to an anticipated financial gain of the preferred travel route;
a navigation controller coupled to the energy control module and configured to navigate the vehicle along the preferred travel route;
a display device coupled to the navigation controller and configured to display the estimated cost and the preferred travel route in real-time on an interactive map; and
a mobile device wirelessly coupled to the energy control module and the navigation controller and configured to display on the mobile device in real time the estimated cost and the preferred travel route and to allow the user to alter the preferred travel route.

16. The continuously variable transmission system for a vehicle of claim 15, wherein the display device displays alternative routes and travel times and costs associated with each alternate route.

17. The continuously variable transmission system for a vehicle of claim 15, wherein the mobile device includes a camera configured to capture a live image and superimpose an augmented reality image on the mobile device in real time.

18. The continuously variable transmission system for a vehicle of claim 15, wherein the continuously variable transmission further includes a camera configured to capture a live image and wherein the display device is configured to superimpose an augmented reality image on the display device in real time.

19. The continuously variable transmission system for a vehicle of claim 15, further comprising a plurality of digital tokens coupled to the mobile device representing recovered regenerated energy value components and recorded on public ledgers including distributed databases.

20. The continuously variable transmission system for a vehicle of claim 15, wherein the plural sensors are further configured to collect information relating to current traffic conditions and weather data.
